(19) United States
(12) Patent Application Publication
(10) Pub. No.: US 2010/0053944 A1
(43) Pub. Date: Mar. 4, 2010

(54) TELESCOPIC FLASHLIGHT

(76) Inventor: CHO YAO-LIN, Taichung County (TW)

Correspondence Address: Chien-Hui Su, P. O. Box 70-121 Taichung, Taichung City, 40899, TW

(21) Appl. No.: 12/202,425

(22) Filed: Sep. 1, 2008

(51) Int. Cl. F21L 4/04

(52) U.S. Cl. 362/198

(57) ABSTRACT

A telescopic flashlight includes a handle provided to receive a battery for providing power. A telescopic shaft is selectively and longitudinally received in the handle. The telescopic shaft includes a series of sleeves slidably received one by one. Each sleeve has a stop structure longitudinally formed thereon to prevent the series of sleeves from rotating relative to one another. A light element is mounted to a free end of the telescopic shaft.

### BACKGROUND OF THE INVENTION

1. Field of the Invention

The present invention relates to a telescopic flashlight, and more particularly to a telescopic flashlight, in which the wires do not twisted.

2. Description of Related Art

A conventional telescopic illumination device in accordance with the prior art comprises handle and a telescopic pipe longitudinally connected to the handle. The telescopic pipe includes multiple tubular structures slidably sleeved on one another and a distal end having a light element mounted thereon. Consequently, the total length of the conventional telescopic illumination device is lengthened and the light element provides lighting effect when being operated.

The handle and the telescopic pipe are longitudinally connected to form an elongated structure. In addition, the battery usually received in the handle and the light element is mounted on the distal end of the telescopic pipe such that a long wire must be disposed in the illumination device for electrically the battery and the light element. However, the tubular structures of the telescopic pipe only can be longitudinally stopped, but is rotatably relative to one another. Consequently, the wires in the conventional telescopic illumination device may be twisted and broken.

The present invention has arisen to mitigate and/or obviate the disadvantages of the conventional telescopic illumination device.

### SUMMARY OF THE INVENTION

The main objective of the present invention is to provide an improved telescopic flashlight, in which the wires do not twisted.

To achieve the objective, the telescopic flashlight in accordance with the present invention comprises a handle provided to receive a battery for providing power. A telescopic shaft is selectively and longitudinally received in the handle. The telescopic shaft includes a series of sleeves slidably received one by one. Each sleeve has a stop structure longitudinally formed thereon to prevent the series of sleeves from rotating relative to one another. A light element is mounted to a free end of the telescopic shaft.

The total length of the telescopic shaft is minimum for being easily carried or an ordinary operation when the telescopic shaft is received in the handle. The telescopic shaft extends and the telescopic flashlight of the present invention can inserted into a small space for an illumination.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a telescopic flashlight in accordance with the present invention;

FIG. 2 is a cross-sectional view of the telescopic flashlight in FIG. 1 when the telescopic shaft is received in the handle;

FIG. 3 is a cross-sectional view of the telescopic flashlight in FIG. 1 when the telescopic shaft extends;

FIG. 4 is a first operational view of the telescopic flashlight in accordance with the present invention; and

FIG. 5 is a second operational view of the telescopic flashlight in accordance with the present invention.

### DETAILED DESCRIPTION OF THE INVENTION

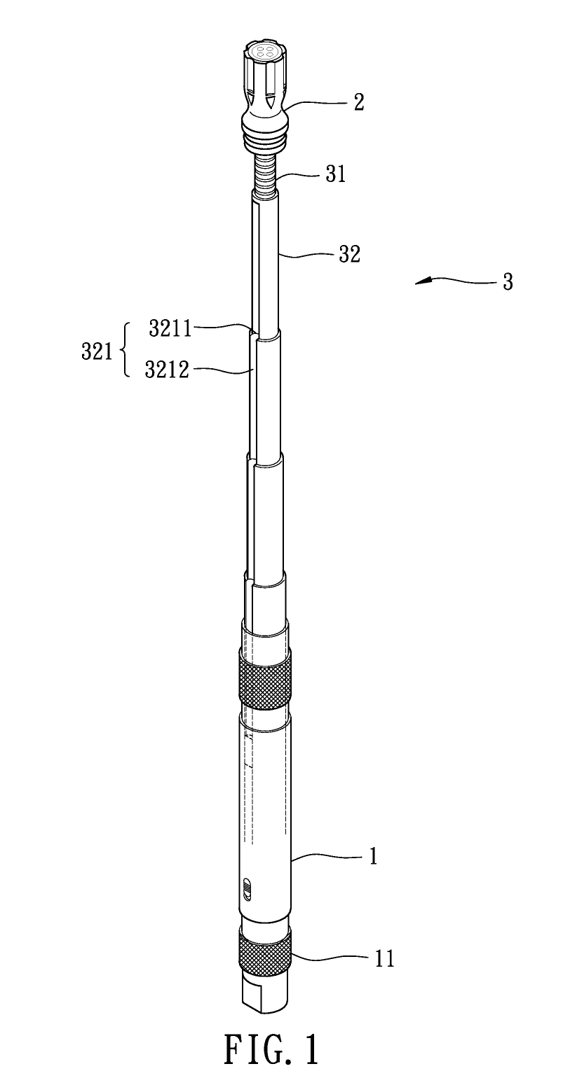

Referring to the drawings and initially to FIGS. 1-3, a telescopic flashlight in accordance with the present invention comprises hollow handle (1) adapted to receive a battery (not shown), a telescopic shaft (3) longitudinally connected to the handle (1), a flexible axle (31) longitudinally connected to a free end of the telescopic shaft (3) and a light element (2) connected to a free end of the flexible axle (31). Consequently, the light element (2) has a universal operation direction.

The handle (1) has a cover (11) detachably mounted to a lower end thereof. The battery can be replaced and the telescopic shaft (3) can be disassembled when the cover (1) is detached from the handle (1).

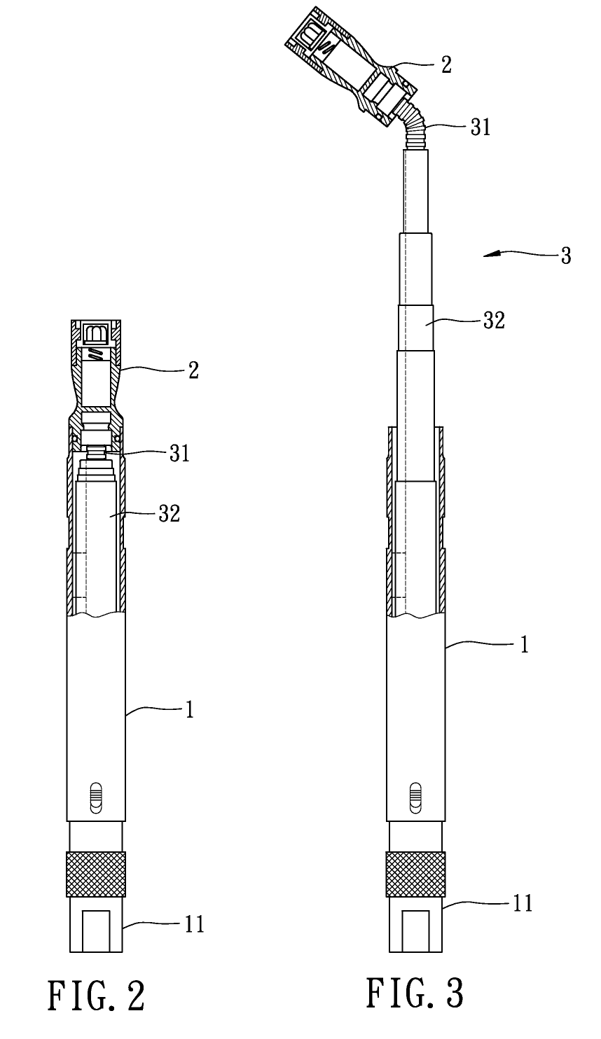

The telescopic shaft (3) is selectively received in the handle (1) as shown in FIG. 2. The telescopic shaft (3) includes a series of sleeves (32) slidably received one by one. The diameter of each of the sleeves (32) is gradually reduced relative to the light element (2). Each sleeves (32) has a stop structure (321) longitudinally formed thereon. The stop structure (321) includes two opposite sides, one having a rib (3211) formed thereon and the other having a groove (3212) defined therein. The groove (3212) is provided to slidably receive the rib of an adjacent sleeve (32) relative to the handle (1), and the rib (3211) is slidably received on in a groove of an adjacent sleeve (32) relative to the light element (2). Consequently, the series of sleeves (32) is unrotatable relative to one another such that the wires in the telescopic flashlight in accordance with the present invention do not twist.

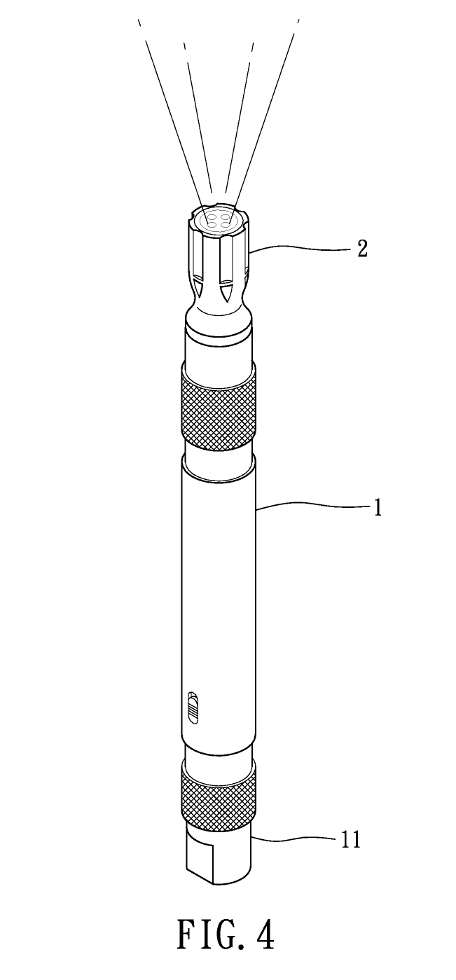

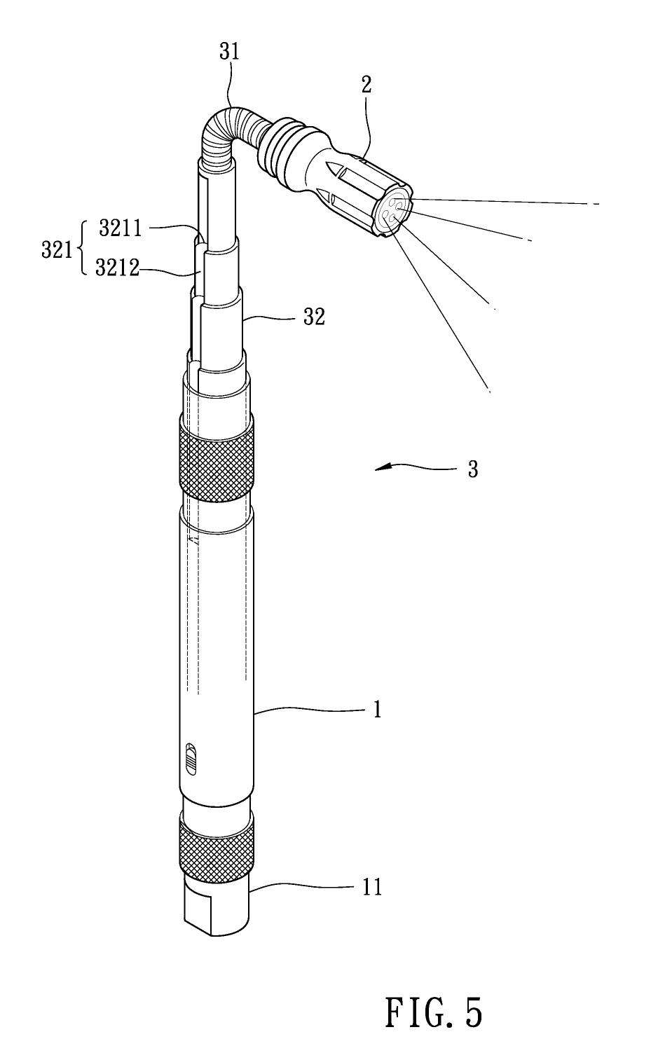

With reference to FIGS. 2 and 4, the sleeves (32) are received one by one such that the total length of the telescopic shaft (3) is minimum and the telescopic shaft (3) is received in the handle (1) for being easily carried or an ordinary operation. With reference to FIGS. 3 and 5, the telescopic shaft (3) extends and the telescopic flashlight of the present invention can inserted into a small space for an illumination. In addition, the light element (2) can be universally operated for determining the lighting direction of the telescopic flashlight.

Although the invention has been explained in relation to its preferred embodiment, it is to be understood that many other possible modifications and variations can be made without departing from the spirit and scope of the invention as hereinafter claimed.

What is claimed is:

1. A telescopic flashlight comprising:
a handle adapted to receive a battery for providing power;
a telescopic shaft selectively and longitudinally received in the handle, the telescopic shaft including a series of sleeves slidably received one by one, each sleeve having a stop structure longitudinally formed thereon to prevent the series of sleeves from rotating relative to one another; and
a light element mounted to a free end of the telescopic shaft.

2. The telescopic flashlight as claimed in claim 1, wherein each stop structure has two opposite sides, one having a rib formed thereon and the other having a groove defined therein, the rib slidably received in the groove of one adjacent sleeve and the groove slidably receiving the rib of the other adjacent sleeve.

3. The telescopic flashlight as claimed in claim 1 further comprising a flexible axle having two opposite ends respectively to the free end of the telescopic shaft and the light element such that the light element is universally operated.

4. The telescopic flashlight as claimed in claim 1, wherein a diameter of each of the series of sleeves is gradually reduced relative to the light element.

5. The telescopic flashlight as claimed in claim 2 further comprising a flexible axle having two opposite ends respectively to the free end of the telescopic shaft and the light element such that the light element is universally operated.

6. The telescopic flashlight as claimed in claim 2, wherein a diameter of each of the series of sleeves is gradually reduced relative to the light element.

7. The telescopic flashlight as claimed in claim 3, wherein a diameter of each of the series of sleeves is gradually reduced relative to the light element.

8. The telescopic flashlight as claimed in claim 5, wherein a diameter of each of the series of sleeves is gradually reduced relative to the light element.
